(19) United States
(12) Patent Application Publication
(10) Pub. No.: US 2017/0280845 A1
(43) Pub. Date: Oct. 5, 2017

(54) MOBILE COMPUTING STORAGE AND DISPLAY UNIT

(71) Applicant: Damian Wynter, Sunrise, FL (US)

(72) Inventor: Damian Wynter, Sunrise, FL (US)

(21) Appl. No.: 15/473,689

(22) Filed: Mar. 30, 2017

Related U.S. Application Data
(60) Provisional application No. 62/316,609, filed on Apr. 1, 2016.

(51) Int. Cl. A45C 11/00; H02J 7/00; A45C 13/30; A45C 13/00; A45C 13/10

(52) U.S. Cl. CPC A45C 11/00; A45C 13/001; A45C 13/10; A45C 13/30; H02J 7/0052; H02J 7/0045; A45C 2011/001; A45C 2011/002; A45C 2011/003; A45C 2200/15

(57) ABSTRACT

The present teachings relate a platform that may fit over a user's thigh to hold in at least one predetermined position a personal electronic device. The platform may include at least one speaker and recharging unit. The platform may also include a mechanism to generally maintain the platform in its operative position, such as on a thigh of a user.

### CROSS REFERENCE TO RELATED APPLICATIONS

This application claims the benefit of and priority to U.S. Provisional Patent application No. 62/316,609, filed on Apr. 1, 2016 and incorporated fully by reference herein.

### FIELD OF INVENTION

The present invention relates generally to a storage and display unit, and more particularly, to an expandable platform to hold a mobile computing device such as a smartphone, tablet, MP3 player and the like.

### BACKGROUND

Various outer cases for mobile computing devices, purchased and installed by users, are available today. Generally speaking, these cases provide a protective shell to guard the device against unintentional impact, scratching, and the like. As used throughout, “mobile computing devices” refers to smart phones, tablet computers, hand-held or similarly sized global positioning system (GPS) device, audio and/or visual players (e.g., MP3 players, e-book readers, etc.), and other devices having an essentially flattened cuboid or polyhedron shape with a display screen presenting on one or more of its faces. In contrast, wearable computing devices (watches, fitness trackers, etc.), desktop computers, and laptop computers and other comparatively larger computing devices having integrally formed, clamshell-style cases may not need or be amenable to the use of a support stand.

U.S. Pat. No. 7,516,933 discloses a portable folding-type cradle. A pair of cradling bodies are connected by a hinge to hold a phone or personal digital assistant in an angled position. When not in use, the cradle is folded over on itself. U.S. Pat. Nos. 8,474,775 and 8,727,295 describe similar foldable and adjustable support stands, while United States Patent Publication 20100315041 discloses a device holder with a quick release charger. United States Patent Publication 20120074286 contemplates a three piece folding stand. In all of these instances, the device being displayed rests in a small, U-shaped cradle with minimal upright backing, so as to enable a compact carrying case when the stand is not in use.

One drawback to these designs is that they incorporate hinge that must rotate over 180 degrees which, if it were to fail, could cause the mobile device to fall. Also, the relative absence of an upright backing makes the devices prone to tipping over if they are accidentally jarred, while the lack of complete support along the outer bottom edges leads to the possibility of lateral displacement (i.e., the device may fall or slide out of these unsupported sides). In all of these instances, the device is subjected to a risk of impact damage. Additionally, all of these stands require a substantially flat surface which, itself, does not move. Taken together, these stands are not optimal for vehicles, trains, or airplanes, where occasional and unexpected jarring motions are often produced.

Another drawback to these stands is that they position the device on the surface upon which they rest, rather than providing additional elevation for more comfortable viewing. While some previously known stands compensate for this lack of elevation by allowing the user to adjust the angle at which the device faces. Further, as the angle of presentation moves further from orthogonal to the flat surface, there is an increased risk of tipping and displacement as noted above.

### SUMMARY OF INVENTION

The present invention contemplates a mobile computing stand that allows for use and/or viewing of a mobile computing device positioned on the on the user's body and/or a flat surface without sliding or tipping. When not in use, the mobile computing device is stored with minimal risk of loss or damage. As such, the inventive storage/display unit may include any combination of the following features:
a tray having a plurality of peripheral walls to receive the device in a storage position and a slot to display the device at an angle that is different than when the device is in the storage position; and
a main body including a pair of flaps, wherein the flaps are positionable: i) in a closed position to conceal the device when the device is in the storage position; and ii) in a opened position to stabilize the storage/display unit when the device is being displayed;
a connectable strap to restrain the flaps in at least one of the closed position and the opened position;
a battery power source integrated with the main body;
a battery power source integrated with the storage cavity;
wherein at least a portion of the peripheral walls engage the device in the storage position to restrain movement of the device;
wherein at least one flap includes a weighted member;
wherein the weighted member facilitates balancing the storage/display unit in the opened position;
wherein each flap includes a weighted member;
wherein the weighted member comprises a fastener;
wherein the weighted member comprises a support frame;
wherein the tray includes a storage cavity;
wherein the storage cavity receives at least one of: a battery, a notebook, a memory device, an audio speaker, a radio, and a lighting device;
wherein the tray includes a kickstand;
wherein the device is positionable within the tray in at least two different displayed positions;
wherein the two different displayed positions include a portrait orientation for the device and a landscape orientation for the device;
wherein the peripheral walls include a groove or gap to allow access to a side wall of the device;
wherein a portion of the strap is formed into at least one storage loop on an inner-facing portion of the flap; and
wherein an inner-facing portion of at least one flap includes a storage compartment.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

Operation of the invention may be better understood by reference to the detailed description taken in connection with the following illustrations, wherein:

FIGS. 1A, 1B, and 1C are perspective views of embodiments of the display unit showing the various orientations in which the device may be displayed.

FIG. 2 is a perspective view of an embodiment of the display unit including an integral securing strap and kickstand backing.

FIGS. 3A and 3B are side views of an embodiment where a device is displayed, respectively speaking, in the portrait orientation shown in FIGS. 1B and 1n a landscape orientation shown in FIG. 1C.

FIGS. 4A and 4B are perspective views of the tray according to certain embodiments.

FIG. 5 is a perspective view of a bottom/downward facing of the tray.

FIG. 6 is a top view of an embodiment of an embodiment of the display unit.

FIGS. 7A, 7B, and 7C are, respectively speaking, perspective, side, and top views of an embodiment in which the tray is provided with an alternative boundary shape.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Generally speaking, the storage and display case of the present invention provides a storage tray with laterally oriented flaps folding over the tray. In the stowed position, the device is effectively encased within the periphery of the tray. The flaps may be opened and fixed in a downward position so as to provide an elevated stand and/or to wrap around a user's legs or torso. An optional securing strap holds the flaps in place in either the open or closed position. Loops, pockets, slots, and other additional storage compartments may be provided on the interior facing portion of the flaps, as well as under or integrated with the tray itself. The tray may further include a kickstand and/or foldable backing to partially or completely support the device when presented in landscape or portrait orientations. Additional electronic components, so as batteries, charging cords, audio speakers, and/or a radio may integrated within the platforms and/or flaps to enhance the overall functionality of the unit.

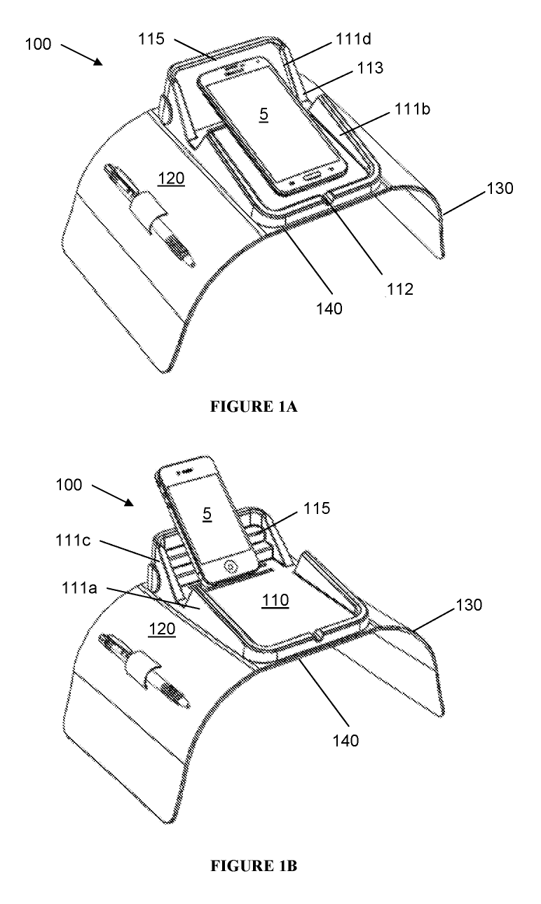

As shown in FIGS. 1A, 1B, and 1C, the storage and display unit 100 carries a mobile computing device 5 within an integral tray 110. Laterally oriented flaps 120, 130 are foldably attached to the main exterior body 140 of the unit 100. As described herein, the “interior” components refer to the elements facing upward when the unit is in its “open” position, as shown in these Figures. In contrast, the exterior or down facing elements will engage with the display surface when the unit 100.

As shown in these figures, unit 100 may be placed on an upper thigh of a user (not shown). The device 5 may remain completely encased, as in FIG. 1A, or be presented in a portrait orientation, as in FIG. 1B, or a landscape orientation, as in FIG. 1C. Each of these positions changes the angle of presentation for the upward facing display screen of the device 5, but without substantially sacrificing the peripheral support structures. In this manner, the device 5 can be displayed even though the unit 5 may be subjected to jostling or jarring owing to the user occasionally shifting leg positions. A user might also be deploy the unit 100 around his or her torso if they are in a prone position.

The exterior facing portions of flaps 120, 130 and main body 140 may present as a continuous surface and stylized accordingly. For example, the outermost portion may include a leather, rubber, fabric, or textured surface (not shown). In addition to adding aesthetic value, these surfaces can be selected to have sufficient friction or grip to minimize sliding movement of the unit 100 when it is opened. The exterior surface can also be selected for comfort, in that it is expected to contact the user's body. Thus, breathable, soft, washable, and/or well-ventilated materials may be used. A combination of differing materials could be provided on the interior and exterior to further optimize user experience.

In some embodiments, the tray 110, flaps 120, 130, and/or body 140 are constructed of a plastic-like vinyl or polyethylene, possibly formed by way of injection-molding to incorporate recesses to accommodate other components and/or storage ports as described herein. Additionally, promotional or decorative indicia (e.g., personalized photos, inspirational quotes, images, and logos from universities, football teams, basketball teams, automotive or other companies, etc.). may be provided on any surface of the unit. Solar active materials may be disposed on the exterior or interior facings of the flaps 120, 130 and/or main body 140. When present, these solar active materials deliver a charging current to the battery and/or directly to the device 5 by way of appropriate wiring (and, optionally, a cord) integrated with or concealed/confined in the unit 100.

The flaps 120, 130 may include integrated weights along the peripheral edges. In one embodiment, the weights are of equal mass. In another embodiment, the weights are selected so that, on the whole, the center of gravity of the unit 100 in its opened state is perfectly balanced. In these manners, the weights ensure that the flaps 120, that extend downward and engage or lie flat on the user's body so as to stabilize and secure the unit. In other embodiments, the weights serve as feet to engage the unit 100 with the supporting surface. The weights may be any appropriately dense, solid mass, including but not limited to metals (such as steel, iron, or other common materials), polymers, or magnets. The selection of integral weight may correspond with the closing functionality described below (e.g., magnets or a magnet-metal combination to facilitate closing of the flaps).

Securing features, such as a zipper, buttons, and/or magnets may be incorporated along or within the peripheral edges of the flaps 120, 130 and, optionally, body 140 to engage and at least partially secure the flaps 120, 130 when the unit is in a closed position. In this regard, the flaps may be aligned edge-to-edge or they may overlap.

The flaps 120, 130 and body 140 may include additional support structure, such as plastic or metal frame, webbing, or extension members. Such a frame may also attach to the tray 110 component. The frame could also rely on spring-loaded or selectively rigid elements to selectively fix the flaps in an effectively orthogonal position relative to the ground or flat surface upon which the open unit 100 is placed.

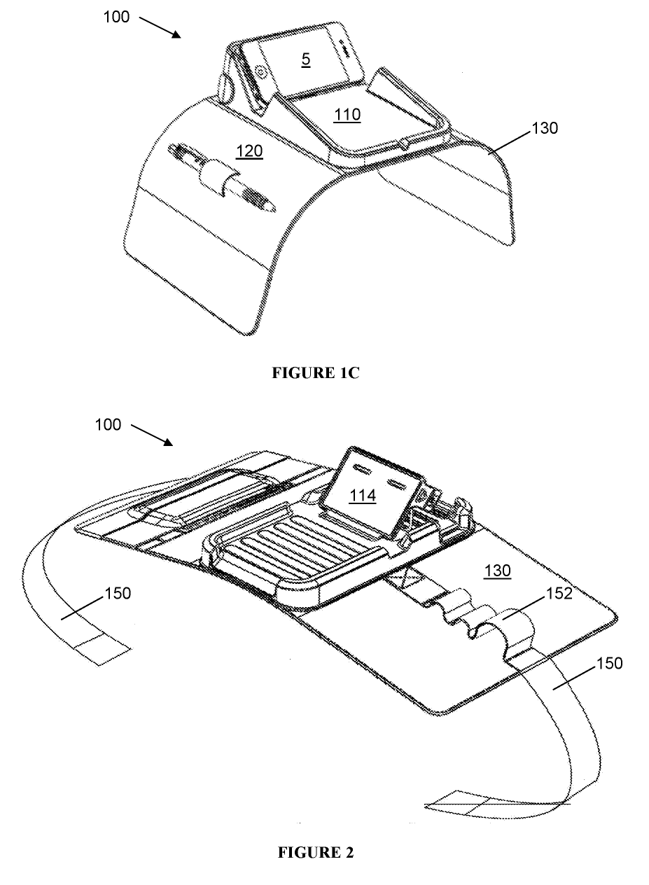

Additionally or alternatively, a security strap 150, as shown in FIG. 2, may be integrated on the interior of the flaps 120, 130. Optionally, the strap could also extend as a single unit across the body 140, underneath or proximate to the tray 110. A series of storage loops 152 may be formed by appropriate attachment points to the interior surface(s) of flap 120 and/or 130, with the main body of the strap 150 itself formed into such loops. Other components, such as a pen, a flashlight, a battery (for integral lights, speakers, device charging, etc. within the tray itself), a backup battery (for separate installation in the device 5 itself), and the like, can be received by these loops 152, as well as the various other pockets and flaps described herein.

The strap 150 may include cooperating fasteners on each of its terminal ends. Such fasteners include Velcro, quick release fittings, magnets, buckles, snaps, and the like. The ends of the strap 150 can be connected when the unit 100 is in its closed position to restrain all of its contents. The strap can also be fastened when the unit 100 is opened, with the connection made either around the user's body (when the unit 100 is resting thereon) or the connection can be made to better secure the flaps as stand-alone legs of an elevated stand, both as will be described in more detail below.

Flaps 120, 130 may be of a sufficiently sturdy construction to allow the unit 100 to stand freely when the unit is opened and placed on a relatively flat surface. In this manner, additional elevation and space may be created between the surface and the actual viewing screen of the device 5, thereby improving the viewing angle without relying on an adjustable hinge or otherwise sacrificing the stability provided by the peripheral elements of the tray.

Flaps 120, 130 and/or body 140 may include a jacket or otherwise be of a construction that allows for cords and other items to be concealed and confined therein. Cords/items be accessible via buttons, zippers, flaps, or apertures to retain a uniform aesthetic when the cords/items are not in use. Additionally or alternatively, mesh pockets or storage straps can be utilized, thereby allowing the user to see any such items that are so confined.

The unit 100 may incorporate have include an integral or detachable audio source; such as by way of a non-limiting example, two speakers, one on the left and one on the right with a short auxiliary cord connecting to the tray 110 and/or the device 5 itself. The speakers in the unit could be powered to enhance sound by a battery pack carried in or on the unit 100 (e.g., in a loop, pouch, or flap on the interior of flap 120 or 130). Such battery packs could be rechargeable and serve as a backup power/charging source for the device itself.

The present teachings are not limited to having both a speaker and a battery pack. Some embodiments may have no speaker or a battery pack, another embodiment may have a speaker but no battery back and yet another embodiment may have speakers and a battery pack. Additional battery-powered devices, such as a radio, one or more lights (preferably, light emitting diodes), and the like, can be incorporated within the unit for enhanced functionality. If present, lights may be integrated on the tray 110 to allow the user to better view the device 5 in darkened conditions. In some embodiments, a stowable notepad may be fitted within the tray 110 or between the tray 110 and the body 140, in which case additional lights may be incorporated and/or automatically activated when the notepad is removed.

In another embodiment, the tray 110 may receive or incorporate a memory device, including but not limited to a USB memory stick, a flash drive, a memory card, and the like. Such memory devices may be in electronic communication with the device, either through a direct connection on the tray or by way of a detachable and stowable cord.

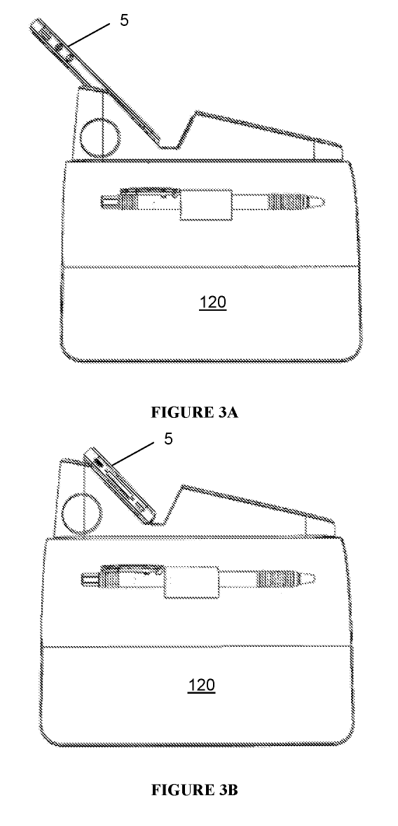

FIG. 3 illustrates a side perspective view to indicate where a battery or battery pack might be integrated into the tray 110. In particular, battery cavity may be formed with access along a lateral side of the tray 110. The cavity may include a cover, or the closing action of the flaps 120, 130 may be sufficient to retain any battery or batteries stored therein. In some embodiments, terminals may be integrated within the tray 110 so as to power a speaker integrally formed in the tray 110 or on one or both flaps 120, 130 (preferably along their interior faces). If the power system is integrated in this manner, a dedicated charging cord could be stowed within a separate integral cavity of the tray to allow for the selective plugging and powering of the device 5. This arrangement could also allow for recharging of the battery/pack itself. Additionally or alternatively, a dedicated charging port along an upright facing of the tray 110 could enable a cord to be attached for battery charging on a periodic basis. The charging functionality may include standardized plugs and power protocols (e.g., USB 3.0, mini-USB etc.) as may be specific to certain devices 5.

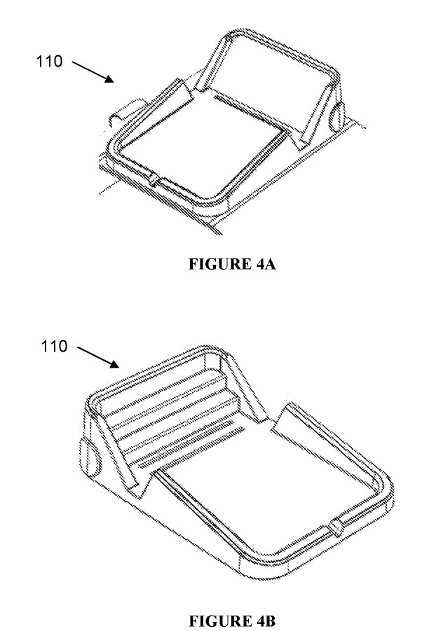

FIGS. 4A and 4B illustrate specific features of the tray 110. Peripheral walls 111a, 111b define a storage space for device 5. In some embodiments, the walls may be spaced and angled to receive a specific device (e.g., an iPhone), possibly even incorporating a snap-fit. In the storage position, the major surface (i.e., the surface incorporating the display screen) is parallel with the major surface of body 140 so that the device 5 is largely encased. This arrangement also simplifies closing the flaps 120, 130 when the unit 100 is being transported or otherwise not in use. Ideally, in the storage configuration, the major surface of device 5 and the top surfaces of walls 111a, 111b (as well as 111c, 111d, described below) present along a common spatial plane so that the flap(s) 120, 130 rest upon a single, and preferably flat, surface.

One or more grooves 112 may be incorporated in the walls 111a, 111b to allow for a power cord and/or audio jack to be accessible while the device 5 is in its storage position. Peripheral display walls 111c, 111d effectively serve as extension of walls 111a, 111b, except that these display walls 111c, 111d may be laterally spaced apart from walls 111a, 111b to define a display slot 113, as will be described in greater detail below. In some embodiments, display walls 111c, 111d extend upward away from the tray 110 at a higher elevation than walls 111a, 111b. The walls 111a, 111b, 111c, and/or 111d may include rounded corners to fit and cooperate with the device 5. In some embodiments, the walls 111a, 111b and 111c, 111d may form contiguous pieces, or additional gaps (beyond that for slot 113) may allow for access to buttons (e.g., volume, power, etc.) or ports (audio jack, power, USB, etc.) located on the sides of the device.

As shown in FIG. 2, a collapsible display kickstand 114 is contained within the space defined by walls 111c, 111d. The kickstand includes a display backing surface 115 that can support the device 5 when it is in a displayed position (i.e., portrait or landscape). The kickstand includes a selectively lockable mechanism (e.g. pins, spring loaded members, a u-bar cooperating with one or more channels along the upward facing surface behind the kickstand, etc.) to ensure the backing 115 remains at an angle position. Multiple kickstand positions can accommodate the landscape view (as shown in FIG. 2), as well as the portrait orientation generally illustrated in FIGS. 1A and/or 1B.

In other embodiments, the kickstand 114 and/or the peripheral walls 111a, 111b, 111c, and/or 111d may be partially retractable, via spring-loaded mechanisms and the like, so that the walls may be urged upward when the device 5 is in a display orientation. In this manner, the device remains supported and secured, thereby reducing the likelihood of tipping, sliding, etc. If provided, the retracting action of the walls and/or kickstand may simply sink into a void space created by the elevation of the tray 110 or telescoping, collapsible segments can be employed. In other embodiments, the display backing may be integrated with and/or disposed between the walls 111c, 111d in a fixed 115 position so as to reduce moving parts and allow for single-step molding of the entire tray 110.

Display slot 113 is defined by a break between walls 111a, 111b and 111c, 111d. The slot 113 is of appropriate size to receive and secure a device 5 in the landscape display orientation (as generally illustrated in FIG. 1C). In some embodiments, the device 5 may overhang slightly, while in other embodiments the device 5 remains positioned entirely within the boundaries of the tray as shown in FIG. 1C.

As seen in FIGS. 4A and 4B, the walls 111a, 111b may rise in elevation as they run along the lateral sides of tray 110. The angle of this elevational rise may cooperate with the elevation of the kickstand 114 and/or display backing 115. When in the portrait orientation, the device 5 may fit within the tray at a lesser angle (as seen in FIG. 1A) or in cooperation with the slot 113 to produce a higher viewing angle (as seen in FIG. 1B).

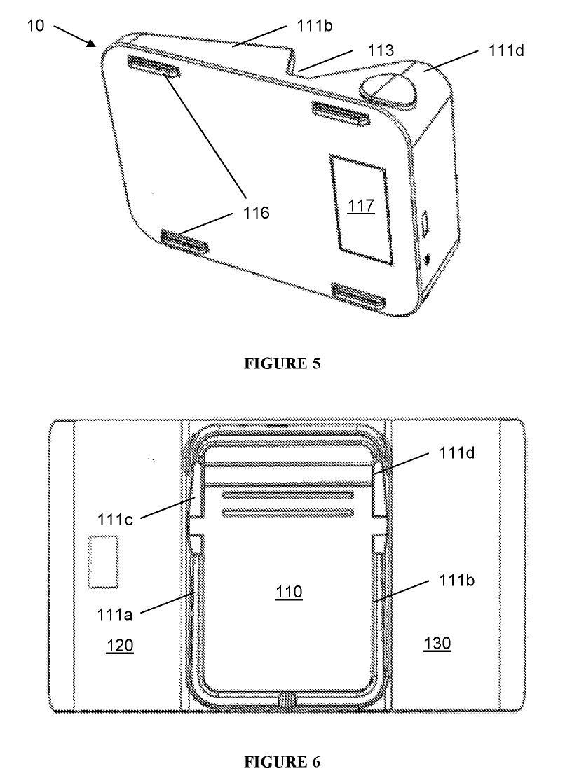

FIG. 5 illustrates a bottom perspective view of only the tray 110. As noted above, the tray may be molded from a single piece of polyethylene and/or other appropriate polymers. As shown here, the battery compartment may be accessible along this bottom facing, in which case the tray 110 should be selectively detachable from the body 140 by way of attachment points 116. These points 116 may be cooperating snap-fits, tongue-in-groove sliding release mechanisms, and the like.

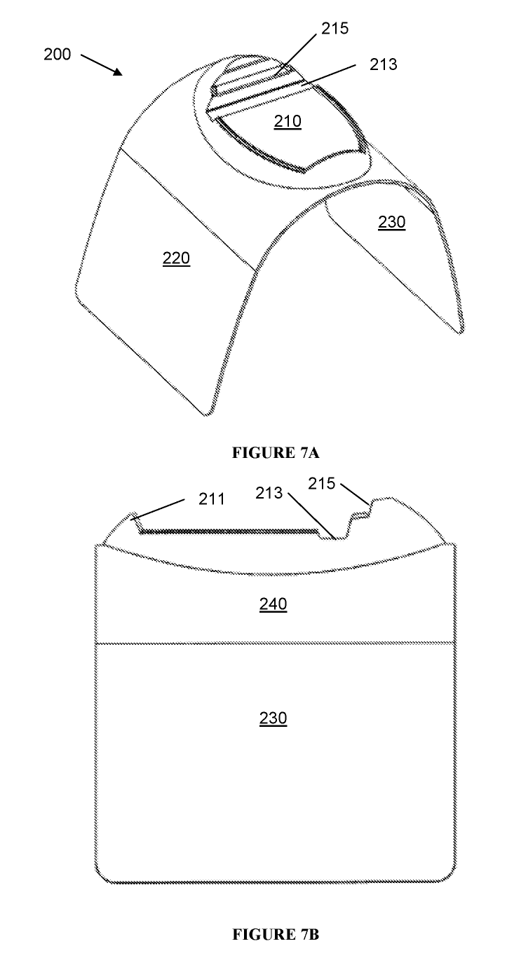

FIG. 6 shows a top view of the unit 100 in the opened position. In some embodiments, the walls 111a through 111d may have variable thickness. Also, the flaps 120, 130 may include a plurality of creases to facilitate the closing action of the unit, as well as to accommodate various opened positions—possibly including the provision of integral feet in the event the unit is designed to stand freely (i.e., without being rested upon the user lap).

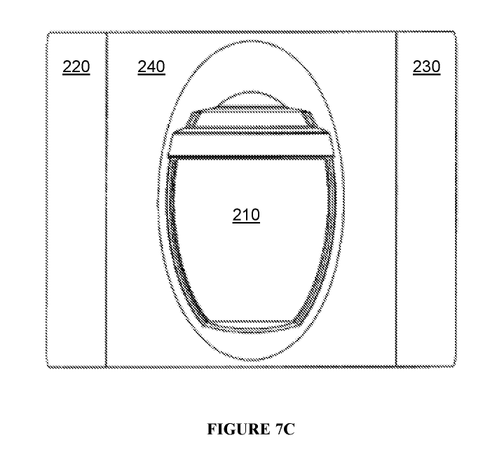

FIGS. 7A, 7B, and 7C are, respectively speaking, perspective, side, and top views of an embodiment of the unit 200 in which the tray 210 is provided with an alternative boundary shape. As shown, a more stylized oval shape is provided to the boundary, although the slot 213 and backing 215 continue to present flat surfaces. Similarly, the wall 211 receives a polyhedron-shaped device (not shown) along its bottom edge, while the backing 215 serves as an effective peripheral wall along the top. Side walls, similar to 111a, 111b may be incorporated. Flaps 220, 230 and main body 240 are similar to the embodiments described above.

In some embodiments, the unit 100 may measure approximately ½ to 1 inch tall, 8 inches long, and 12 inches wide. While the dimensions are disclosed, the present teachings are not limited to such. The platform may be of any appropriate size and shape.

The top of the platform may include a recess with an inclined surface for placement and containment of the portable electronic device brought along by the user. A short auxiliary cord may also be included to plug into the electronic device for playing music.

While sitting, the use may have this product set on the thigh while containing the MP3 player, GPS, small tablet, or smartphone. The individual may keep the portable electronic device stabilized and readily accessible atop the thigh while also playing music. This battery-powered platform may also be portable for use almost anywhere outside a vehicle, if desired.

Instead of always having a smartphone or MP3 player fall off the lap and onto the floor while traveling, this specially-designed product would hold and stabilize the portable electronic device atop the user's thigh.

A user may enjoy music playing through speakers for a smartphone or MP3 player for added travel enjoyment and personal entertainment. It may stabilize a GPS for quick reference without sticking it onto the inner windshield or placing it on the seat. In addition, the platform may be user-friendly, lightweight, comfortable, versatile, and practical.

The invention may be particularly useful to a user while waiting to catch a flight, sitting on a train, watching a game or any time you are sitting around while accessing the personal electronic device.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

Having thus described the invention, the following is claimed:

1. A storage/display unit for a mobile computing device comprising:
a tray having a plurality of peripheral walls to receive the device in a storage position and a slot to display the device at an angle that is different than when the device is in the storage position; and
a main body including a pair of flaps, wherein the flaps are positionable: i) in a closed position to conceal the device when the device is in the storage position; and ii) in a opened position to stabilize the storage/display unit when the device is being displayed.

2. The storage/display unit of claim 1, wherein at least a portion of the peripheral walls engage the device in the storage position to restrain movement of the device.

3. The storage/display unit of claim 1, wherein at least one flap includes a weighted member.

4. The storage/display unit of claim 3, wherein the weighted member facilitates balancing the storage/display unit in the opened position.

5. The storage/display unit of claim 3, wherein each flap includes a weighted member.

6. The storage/display unit of claim 3, wherein the weighted member comprises a fastener.

7. The storage/display unit of claim 3, wherein the weighted member comprises a support frame.

8. The storage/display unit of claim 1, wherein the tray includes a storage cavity.

9. The storage/display unit of claim 8, wherein the storage cavity receives at least one of: a battery, a notebook, a memory device, an audio speaker, a radio, and a lighting device.

10. The storage/display unit of claim 9, further comprising a battery power source integrated with the storage cavity.

11. The storage/display unit of claim 1, further comprising a battery power source integrated with the main body.

12. The storage/display unit of claim 1, wherein the tray includes a kickstand.

13. The storage/display unit of claim 1, wherein the device is positionable within the tray in at least two different displayed positions.

14. The storage/display unit of claim 13, wherein the two different displayed positions include a portrait orientation for the device and a landscape orientation for the device.

15. The storage/display unit of claim 1, wherein the peripheral walls include a groove or gap to allow access to a side wall of the device.

16. The storage/display unit of claim 1, further comprising a connectable strap to restrain the flaps in at least one of the closed position and the opened position.

17. The storage/display unit of claim 16, wherein a portion of the strap is formed into at least one storage loop on an inner-facing portion of the flap.

18. The storage/display unit of claim 1, wherein an inner-facing portion of at least one flap includes a storage compartment.
